(19) United States
(12) Patent Application Publication
(10) Pub. No.: US 2024/0204999 A1
(43) Pub. Date: Jun. 20, 2024

(54) METHODS AND SYSTEMS OF MULTI-USER QUANTUM KEY DISTRIBUTION AND MANAGEMENT

(71) Applicant: HUAWEI TECHNOLOGIES CANADA CO., LTD., Kanata (CA)

(72) Inventors: Wen TONG, Kanata (CA); Sheng SUN, Kanata (CA)

(73) Assignee: HUAWEI TECHNOLOGIES CANADA CO., LTD., Kanata, ON (CA)

(21) Appl. No.: 18/414,952

(22) Filed: Jan. 17, 2024

Related U.S. Application Data
(63) Continuation of application No. PCT/CA21/51034, filed on Jul. 23, 2021.

(51) Int. Cl. H04L 9/08; H04L 9/32

(52) U.S. Cl. CPC H04L 9/0861; H04L 9/3242

(57) ABSTRACT

Methods of distributing a quantum-based cryptographic key to multiple network nodes. A multi-user quantum key distribution from one node to two further nodes can be extended to a binary tree structure where any further node can participate in quantum key distribution with its two child nodes. A key generated in a 3-node subgroup can be stitched with a key from of a parent 3-node subgroup, or a child 3-node group, and key confirmations can be provided through authenticated classical channels. Classical channels can also be used to communicate and relay membership updates, allowing a key operator at a binary tree's root node to update keys accordingly.

### RELATED APPLICATIONS

The present application is a continuation of International Application No. PCT/CA2021/051034 filed Jul. 23, 2021 and entitled “METHODS AND SYSTEMS OF MULTI-USER QUANTUM KEY DISTRIBUTION AND MANAGEMENT”, the contents of which are incorporated herein in their entirety.

### FIELD OF THE INVENTION

This invention pertains generally to the field of quantum cryptography and in particular, to methods and systems of quantum key distribution when the number of parties involved is changed.

### BACKGROUND

Key distribution to multiple parties, such as the Group Diffie-Hellman protocol (GDH) and the Group Key Management Protocol (GKMP), can provide the ability to create and distribute a key within a group of arbitrary size, without the intervention of a globally centralized key operator. In some circumstances however, a centralized key operator may be desirable, for example to allow monitoring of subgroups, without the subgroups being allowed to monitor each other unless it is via the centralized key operator. The prior art lacks a model in which a key operator can monitor subgroups, while subgroups are prevented from monitoring each other, i.e., subgroups have no direct trust relationships. Further, the computation of a group key with the GDH protocol is an exponential one, which suggests room for increased simplification or efficiency.

A quantum-based key can be seen as a string of bits (i.e. 0's and 1's), each bit having been determined by quantum level randomness. A protocol referred to as multi-user quantum key distribution (MU QKD) refers to a symmetrical communication of such a key, from one party to two other parties, as well as related verifications. A MU QKD protocol however, has so far been limited to a 3-party distribution.

Methods and systems are therefore required to obviate or mitigate one or more limitations of the prior art, by allowing a key manager to have trust relations with subgroups, while no direct trust relations exist between the subgroups, by simplifying the computation of a group key, and by increasing, and then reducing, the number of parties in a MU QKD scheme.

This background information is provided to reveal information believed by the applicant to be of possible relevance to the present invention. No admission is necessarily intended, nor should be construed, that any of the preceding information constitutes prior art against the present invention.

### SUMMARY

Embodiments include methods to extend a 3-party quantum key distribution scheme to more than three parties, using a trust model in which a central key operator can monitor and have trust relations with subgroups, while the subgroups are prevented from monitoring each other and have no trust relations with each other. A trust model according to an embodiment can be based on a binary tree structure having a central key operator at the root, which is compatible with a 3-party quantum key distribution, and which can be extended to further parties, by having any tree node act as a secondary operator for its child nodes, and as an intermediary with its own parent node. The computation of a group key with an embodiment can be linear, which provides increased computation simplification and efficiency over prior art. Additionally, embodiments include systems and methods to update a group-based, multiple user (MU) key when a node leaves a network, in order to respect forward secrecy requirements.

Embodiments can allow multiple parties of a network to communicate with each other using a quantum-based key, where if a party joins or a party leaves the network, the key can be updated by a central operator.

With a network configured as a binary tree network, a quantum-based key can be derived between an operator node and at least one of its two child nodes. Another quantum-based key can be derived between one of the child nodes, and at least one of its own child nodes. The two keys can be then be sent to the operator node to be combined into a quantum-based key that is common for at least three non-successive nodes. Embodiments therefore allow communication between non-successive nodes to benefit from a quantum-based key and its high level of security.

Furthermore, with embodiments, a quantum-based key can be updated when a node joins, and when a node leaves the network and updating the key is a linear process, which is simpler than with updating techniques of the prior art.

A key distribution network according to an embodiment allows a central operator to maintain a trust relationship with other nodes, while other nodes have no trust relationships with each other unless via the operator. This is because updating a key can be performed by the operator.

Embodiments include a method of generating a key comprising: deriving a first key with a first node and a second node, deriving a second key with the second node and a third node, encrypting the first key with the second key, encrypting the second key with the first key, sending the encrypted first key to the third node, sending the encrypted second key to the first node, and deriving a stitched key from the first key and the second key; wherein a key is a cryptographic key made from a string of bits, the first node has a direct connection with the second node, and the second node has a direct connection with the third node. In embodiments, deriving a stitched key can be performed with a key derivation function (KDF). In embodiments, a key derivation function can be a hash-based message authentication code (HMAC) key derivation function (HKDF). In embodiments, deriving a stitched key from a first key and a second key can be performed by concatenating the first key and the second key. In embodiments, each node can be a node of a binary tree, the first node can be a parent node to the second node, the second node can be a child to the first node and a parent to the third node, and the third node can be a child to the second node. In embodiments, deriving a first key and deriving a second key can include at least one node sending a string of qubits to at least one receiving node, each qubit being in a state of 2-qubit entanglement. In embodiments, there can be a confirmation that the stitched key is common to the first and third node, the confirmation comprising the second node: receiving from the first node a message including: a confirmation request, and a signature of the first node; sending to the third node a message including: the confirmation request, the signature of the first node, a signature of the second node; receiving from the third node a message including: a confirmation response, a signature of the third node; sending to the first node a message including: the confirmation response, the signature of the third node, a signature of the second node. In embodiments, the signature of a node can include an integrity key derived with a key derivation function, the inputs of which can include at least: the stitched key, an identifier of the sending node, and an identifier of the receiving node. In embodiments, a key derivation function can be a hash-based message authentication code (HMAC) key derivation function (HKDF). In embodiments, inputs of a key derivation function can include an identifier of a relaying node.

Embodiments include a method of updating a cryptographic key for nodes of a binary tree network, comprising a first node: receiving from a second node a group update request for the deletion of a third node, sending to the second node a group update response and a signature of the first node, sending to the second node a group key update and a signature of the first node, sending to a fourth node a group key update and a signature of the first node; wherein the first node is a parent node to the second and fourth node, and the second node is a parent node of the third node. In embodiments, a method of updating a cryptographic key for nodes of a binary tree network can further include the first node: sending to a least one other node a group key update and a signature of the first node.

Embodiments include a system for performing quantum key distribution to multiple nodes comprising at least three nodes of a binary tree, the first node parent node to the second node, the second node a child to the first node and a parent to the third node, and the third node a child to the second node, each node operative to participate in quantum key distribution based on qubits in a state of 2-qubit entanglement. In embodiments, a system can include a second node and third node operative to derive a key between the second node and the third node, a first node and second node operative to derive a key between the first node and the second node, the second node operative to encrypt a key with another key and send the encrypted key to another node, the first node operative to derive a group key for the first node, second node and third node using the key between the second node and the third node, and the key between the first node and the second node. In embodiments, a system can further comprise one or more classical channels to communicate from one node to another node: key confirmation requests and key confirmation responses.

Embodiments include a machine readable medium storing machine readable instructions which when executed by a processor of a first node can configure the first node for receiving from a second node a group update request for the deletion of a third node, sending to the second node a group update response and a signature of the first node, sending to the second node a group key update and a signature of the first node, sending to a fourth node a group key update and a signature of the first node; wherein the first node is a parent node to the second and fourth node, and the second node is a parent node of the third node. In embodiments, a machine readable medium can include a first node further configured for: sending to a least one other node a group key update and a signature of the first node.

Embodiments include a machine readable medium storing machine readable instructions which when executed by a processor of a second node configures the second node for generating a key comprising: deriving a first key with a first node and the second node, deriving a second key with the second node and a third node, encrypting the first key with the second key, encrypting the second key with the first key, sending the encrypted first key to the third node, sending the encrypted second key to the first node, and receiving a stitched key from the first node, the stitched key derived by the first node from the first key and the second key; wherein a key is a cryptographic key made from a string of bits, the first node has a direct connection with the second node, and the second node has a direct connection with the third node. In embodiments, a stitched key can be a hash-based message authentication code (HMAC) key. In embodiments, deriving a first key can include a first node sending a string of qubits to a second node, each qubit being in a state of 2-qubit entanglement.

In some embodiments, a node such as the second node can be a user equipment device (UE).

### BRIEF DESCRIPTION OF THE DRAWINGS

FIG. 1 illustrates a multi-user quantum key distribution (MU QKD) network having a binary tree structure, according to an embodiment implementing photonic qubits.

FIG. 2 illustrates a multi-user quantum key distribution (MU QKD) network having a binary tree structure according to an embodiment, where emphasis is placed on subgroups and related group keys.

FIG. 3 illustrates a group of three network nodes and the trust relations between the nodes, according to an embodiment.

FIG. 4 is a call flow diagram illustrating steps allowing group key stitching, according to an embodiment.

FIG. 5a illustrates parts of a message requesting confirmation of a stitched group key, from an operator node O to a node C, according to an embodiment.

FIG. 5b illustrates parts of a message requesting confirmation of a stitched group key, from a node A to a node C, according to an embodiment.

FIG. 5c illustrates parts of a message requesting confirmation of a stitched group key, from a node C to an operator node O, according to an embodiment.

FIG. 5d illustrates parts of a message requesting confirmation of a stitched group key, from a node A to an operator node O, according to an embodiment.

FIG. 6a illustrates a method by which an integrity key can be reconstructed from node identifiers and a group key, and be used to create a signature for a sending node, according to an embodiment.

FIG. 6b illustrates a method by which an integrity key can be reconstructed from node identifiers and a group key, and be used to create a signature for a sending node, according to an embodiment where nodes are those defined in FIG. 1-5.

FIG. 7 is a call flow diagram illustrating steps allowing a stitched group key to be confirmed, according to an embodiment.

FIG. 8 illustrates the removal of a node as it leaves a binary tree network, according to an embodiment.

FIG. 9 is a call flow diagram illustrating a process for removing one or more nodes leaving a binary tree network, according to an embodiment.

FIG. 10 is a block diagram of an electronic device (ED) illustrated within a computing and communications environment that may be used for implementing the devices and methods disclosed herein.

### DETAILED DESCRIPTION

A centralized trust model in which a key operator can monitor subgroups of nodes (i.e. parties), and the subgroups rely on the key operator without being able to monitor each other, and without having direct trust relations with each other, can be implemented with a binary tree network structure according to an embodiment. A binary tree structure is also compatible with a 3-party quantum key distribution scheme in which any node (i.e. vertex) can be a party. In an embodiment implementing a binary tree structure, any node of the binary tree can symmetrically send keys to two subsequent nodes (child nodes), thereby allowing a multi-level, or layered structure including more than three nodes. When acting as a sender, a node of a binary tree is a parent node to two other nodes, and can be referred to as a leader node. A binary tree structure has one root node, which can be referred to as the operator node. In embodiments, any group of three parties including one parent node acting as a leader, and two child nodes acting as receivers, can be referred to as a subgroup. Subgroups that are related to the root node (i.e. operator node) by the same number of intermediary nodes can be said to be in the same layer. The layer including the root node can be referred to as “layer 1”.

A scheme according to an embodiment, for an operator node to manage multiple layers of subgroups can be referred to as a key stitching (KS) trust model. In an embodiment, key stitching is a process by which a node receiving a first, or layer 1 key from an operator node, can generate a second, or layer 2 key to send to further nodes, and the first and second keys can then be congregated through the operator node to make a common key for layer 1 and layer 2. In an embodiment, a receiving node that also generates a key can be referred to as a subgroup “leader”. Further, compared to prior art in which a group key computation is exponential, a group key computation of an embodiment can be linear.

The linear overhead is due to the group dynamics of nodes joining or leaving a network. A QKD protocol needs a communication overhead with four messages round trips with the operator O only. If N represents the number of nodes in a network, this can be represented as O(4N). With a protocol such as the Group Diffie Hellman (GDH) protocol, group key computation is better represented with O(Nm), which is exponential.

Embodiments are applicable with a 3-party quantum key distribution scheme by which a quantum-based key can be generated, processed and distributed as a string of bits from an operator node, to two other separated parties (i.e. the first two child nodes of a binary tree structure), and where key security, or the secrecy of bit values, are validated through quantum mechanisms and quantum-based principles. A 3-party quantum key distribution scheme, referred to as multi-user quantum key distribution or MU QKD, is described in PCT/CA2021/050738.

Embodiments can include at least one authenticated classical channel, which can be used communicate and compare versions of a key as received by different parties, i.e. to obtain key agreements involved in a distribution scheme.

In embodiments applied to a multi-user (i.e. the number of users being N≥2) quantum key distribution (MU QKD) protocol, key security and/or secrecy can be based on states of 2-qubit entanglement where a Bell inequality is violated. This scheme improves or ensures non-malleability and protection against eavesdropping.

Embodiments can combine MU QKD with a key stitching trust model providing a simplified mechanism to symmetrically distribute and share a key to further layers of subgroups, beyond the first two receivers (i.e. beyond layer 1), so as to expand key distribution to multiple layers and multiple members. A key for one layer can be stitched to a key for another layer. For example, a layer 1 key, distributed from the operator node to its two child nodes, can be stitched to a layer 2 key, distributed from a child node of layer 1 to a child node of layer 2. Further, a key stitching trust model can be supplemented with systems and methods to update a group-based multiple user key when a party leaves a network, in order to respect forward secrecy requirements.

In embodiments, a key can be a string of bits, each one determined by quantum scale randomness. Before being determined, a bit can be a quantum bit, or “qubit”, which can be seen as a bit of information that is in a superposition of two outcome states, typically written with notation of the art as |0 [symbol] and |1 [symbol] (as opposed to 0 and 1 for classical bits). In an embodiment, a qubit can have two possible outcome states |0 [symbol] and |1 [symbol] when measured, and an initial (pre-measurement) state of superposition ψ can be expressed as:

$$ψ = a \vert 0 〉 + b \vert 1 〉 \qquad ( 1 )$$

where a and b respectively correspond, indirectly via further calculations, to a probability of each outcome state of the superposition, which in an embodiment can be 50%. A state |0 [symbol] is one possible outcome state of a qubit, and a state |1 [symbol] is the other possible outcome state, and each possibility can have a 50% chance of occurring, the result for each qubit being random by nature. Once an outcome is known, by a process referred to as “measurement”, which depends on how the qubit was implemented and generated, it can be used as a classical bit, i.e. 0 or 1, to make a string which can be used as a key. Such a key is therefore referred to as a quantum-based key, or simply as a quantum key. A quantum key can be a string of bits, each bit having been determined randomly according to quantum level randomness.

In an embodiment, when a qubit is first generated and sent, its state can be undetermined and when received by a network node, the qubit's state can be measured and thus determined as either a 0 or a 1, the value being random. At the quantum scale of a qubit, which can be implemented as a single particle, a single atom, or another entity having measurable quantum properties, the measurement itself causes the qubit to be in a determined state, and a measurement can be performed such that only one of two results is possible. The two possible outcomes can be labelled as state |0 [symbol] and state |1 [symbol] and after measurement, once a qubit has become a classical bit, as simply 0 or 1. For example, if a qubit is a photon in a random (quantum) state of polarization, measuring the polarization, typically with a polarizer, causes the photon to be in a determined (classical) state of polarization.

A quantum-based key (i.e. quantum key) can be a string of bits (i.e. 0's and 1's), each bit having been determined randomly based on physical, quantum-scale phenomena. When first sent, a quantum bit (qubit) can be undetermined, but at the point of reception, the state of the qubit can be measured, and as a qubit, the state can be determined as either 0 or 1. If the point of reception is an undesired interceptor (e.g. cavesdropper), the qubit becomes a determined bit, and its random nature is lost. In a hypothetical scenario, an interceptor can measure a bit and obtain 1 for example. To conceal its presence, the interceptor would send a conventional bit 1 to the intended receiving node. However, with a properly designed systems and methods, a receiving node measuring the bit as 0 or 1 can statistically determine whether the bit was sent as a random qubit, or whether it was sent as a classical bit by an interceptor having first received and measured the original qubit.

A state of 2-qubit entanglement is a state involving two qubits, interacting such that each qubit cannot be described independently. Instead, the two qubits must be described as one entity. As an example, if two qubits are not entangled, there are four possible outcome states for the pair: |00 [symbol] , |01 [symbol] , |01 [symbol] , and |11 [symbol] , where in |xy [symbol] , x is the bit value of one bit of a pair, and y is the bit value of the other bit of a pair. However, if the two qubits are entangled, the measurement outcomes are limited to two possibilities: |00 [symbol] or |11 [symbol] . The generation of multiple qubits where each qubit is entangled to one other qubit can result in the creation of two strings of entangled qubits representing two copies of a key. With subsequent processing, the two strings can be compared. If during comparison, many bits of a string are shown to be in states of non-entanglement, i.e. if many |01 [symbol] , or |10 [symbol] states are present, it can be concluded that the qubit transmission has been compromised and the key is not secure. If, however, the states of most bits are in accordance with the originating qubits being entangled, i.e. if a significant number of |00 [symbol] and |11 [symbol] states are present, and very few |01 [symbol] , or |10 [symbol] states are present, then the key has not been compromised, it can be considered secure, and it can be used. Because interception of a string of qubits can cause entangled qubits to become conventional bits, interception can cause an increased proportion of |01 [symbol] and |10 [symbol] states, causing the key to be rejected. Excessive noise, however, can also cause states |01 [symbol] and |10 [symbol] states, and so evaluating the security of a key should consider environmental noise.

If two qubits are entangled, only two outcome states are possible. A quantum state of 2-qubit entanglement can be represented as:

$$\begin{matrix}ψ = \frac{1}{\sqrt{2}} \vert 00 〉 + \frac{1}{\sqrt{2}} \vert 11 〉 \\ ψ = \frac{1}{\sqrt{2}} ( \vert 00 〉 + \vert 11 〉 )\end{matrix} \qquad ( 1 )$$

where:
   |00 [symbol] represents one possible outcome state of the entangled qubits (both being 0),
   |11 [symbol] represents the other possible outcome state of the entangled qubits (both being 1), and
the

$$\frac{1}{\sqrt{2}}$$

multiplier corresponds to a 50% probability for each outcome state to be measured.

In a group communication, when members of a group need to securely exchange a message, the generation of a group key can be required, where a group key is one that is common to all members of the group. For example, in mobile multicast communications, a method of key distribution is the Authentication and Key Agreement (AKA) protocol. Such a protocol can depend on the secrecy of a root key (K), in that an unauthorized modification or compromise in a root key K can lead to information leakage. With a multi-user quantum key distribution (MU QKD) method based on states of 2-qubit entanglement according to embodiments, the risk of unauthorized modification or compromise of the key can be reduced significantly and possibly to an arbitrarily low level, depending on implementations. Compared with a fully classical computation environment, a multi-user quantum key distribution (MU QKD) method according to embodiments can provide improved security against an interceptor (i.e. eavesdropper, man-in-the-middle (MITM)) attack, because in embodiments, the measurement of many non-entangled states (i.e. states |01 [symbol] and |10 [symbol] ) can indicate an interception of the initial transmission of the string of entangled qubits.

Embodiments can include a 3-party multi-party quantum key distribution (MU QKD) scheme, wherein a key operator (parent node acting as a leader node) can generate 2 strings of entangled qubits as two copies of a key being distributed from the key operator to two other separated parties (child nodes acting as receiver nodes). The two copies of the string of qubits can be processed, compared and validated to become a classical bit key that can be shared amongst all 3 parties, and for this purpose, embodiments can also include one or more authenticated classical channels, to communicate agreements involving different copies of a distributed key.

To be secure, a key distribution to multiple users using a MU QKD scheme can depend on physical proximity between a sending node and a receiving node. If a quantum-based key is to be distributed to a user equipment (i.e. UE such as a mobile handset) according a MU QKD scheme based on 2-qubit entanglement, the UE should be close enough to the source of generated qubits to securely receive the entangled qubits. As the distance increases, so do the chances of qubits being disturbed by interception or noise. The security of a quantum-based key can therefore increase as the distance between a source and a receiving node is decreased.

Because of the entanglement feature referred to in the art as “quantum non-locality”, the delivery of a key to multiple users using a MU QKD scheme can be very secure. Quantum non-locality can refer to the experimental observation that when two qubits are entangled and their state is undetermined, measurement of one qubit instantly determines the state of the other qubit, irrespective of where each one is located. The state of a qubit is therefore not necessarily determined by “local” conditions, but can be determined by a measurement at the other qubit's location. Expressions referred to as Bell inequalities can be used to express whether or not qubits are entangled. Typically, if two qubits are not entangled, a Bell inequality is satisfied. However, a state of 2-qubit entanglement does not satisfy the Bell inequality, and therefore, if a Bell inequality is not satisfied, it can indicate the presence of entangled qubits. From a Bell inequality, when involving an interceptor (i.e. eavesdropper), the probability of two qubits being entangled, can be expressed as follows:

$$E ( A C ) + E ( CB ) ≪ E ( AB ) \qquad ( 2 )$$

where:
E(AC) denotes the expectation value (i.e. probability) of a bit at receiving node A being entangled with a bit at an interceptor (C)
E(CB) denotes the expectation value (i.e. probability) of a bit at receiving node B being entangled with a bit at an interceptor (C)
E(AB) denotes the expectation value (i.e. probability) of a bit at receiving node A being entangled with a bit at receiving node B

Equation (2) states that the probability of entanglement E(AB) between a qubit received by receiving node A and a qubit received by receiving node B, is much greater than the probability of a qubit received at an cavesdropper C being entangled with one at either A or B. In other words, if a qubit is received by an cavesdropper, the probability of it being entangled to a bit at receiving node A or B, is so low as to be negligible. Therefore, the level of security of a quantum-based key can be evaluated by counting how many of its qubits were received in a state of 2-qubit entanglement.

Embodiments can include a multi-user quantum key distribution (MU QKD) method such as 2-qubit MU QKD, as well as key stitching, such that a same key can be further shared with a plurality of network nodes, thereby expanding MU QKD to multiple layers of multiple members. A first node can be a centralized operator node O responsible for an initial MU QKD, for key stitching, and for implementing trust relations with further nodes (i.e. key stitching trust model). In an embodiment implementing a 2-qubit MU QKD protocol in a binary tree structure, the operator node O can deliver keys symmetrically to its child nodes: receiving node A and to receiving node B, and together, operator O, node A, and node B can be said to form a network's core layer, or layer 1 of a MU QKD network. Layer 1 can include one trust group, the members being operator node O, node A and node B. Nodes A and B can be respectively be referred to as “Alice” and “Bob”.

In an embodiment, each of receiving node A and receiving node B can also act as a further sender, by generating pairs of entangled qubits that can be sent to further child nodes. If there is MU QKD from node A to receiving child nodes C and D, then nodes A, C and D can be referred to as another trust group, and if there is MU QKD from node B to receiving child nodes E and F, then nodes B, E and F can be referred to as yet another trust group. In an embodiment, any MU QKD from node A to node C and D, and/or from node B to nodes E and, can be referred to as a layer 2 QKD or a layer 2 MU QKD.

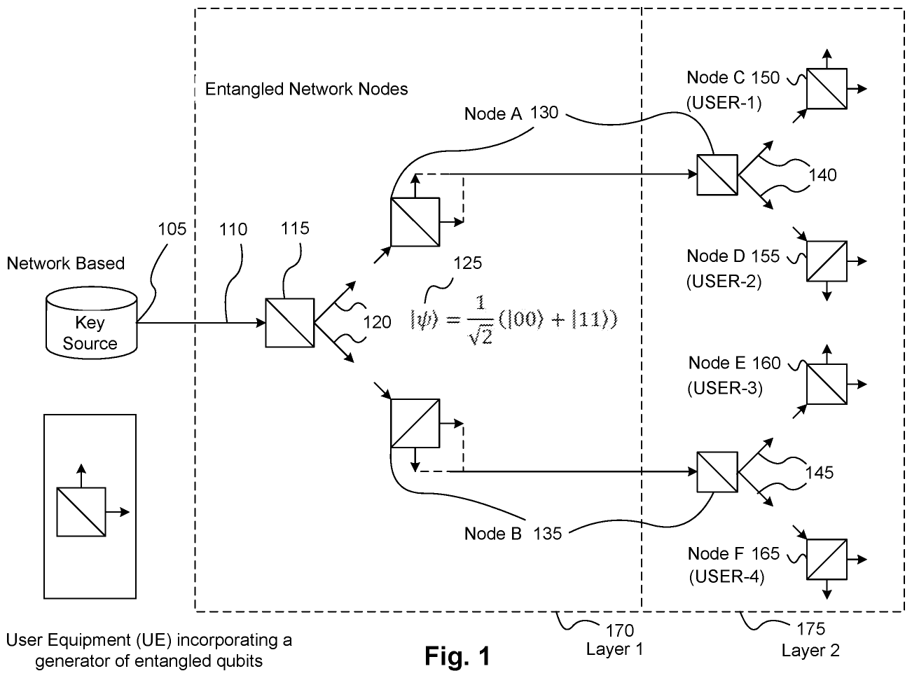

FIG. 1 illustrates a MU QKD network having a binary tree structure, according to an embodiment. In an embodiment where a string of qubits is implemented as a string of photons, a key source 105 can generate a string of photons 110, and the photons can be received by a polarizing beam splitter 115 producing pairs of entangled qubits 120. Each pair of entangled qubits can be said to be in a Bell state, which can be expressed as equation (1) 125. The first polarizing beam splitter 115, generating entangled qubits can be referred to as a key operator node, or operator O. By producing many pairs of qubits in sequence, each qubit in a state of 2-qubit entanglement, two copies of a string of qubits can be produced, each qubit of a copy being entangled to a qubit of the other copy, and each copy can be sent to a different receiving node. A first string of qubits can be sent to node A 130 and a second string of qubits, each one entangled to a qubit of the first string, can be sent to node B 135.

When a qubit is received at node A 130, its state of polarization can be measured with a polarizing beam splitter. The measurement results, which can be in either one of two states, can be recorded in a memory associated with node A, as a conventional bit of 0 or 1, depending on the measurement result. Likewise, a node B 135 can perform similarly with the other entangled qubit of the pair. Later on, the strings recorded at node A can be compared with the string recorded at node B, and if their level of entanglement is sufficient, i.e. if the string received at node A is sufficiently similar to the string received at node B, as determined by a user, they can be made similar or identical, by having non-similar bits deleted, and the final string can be used as a key.

In an embodiment, a receiving node A 130 and a receiving node B 135 can also act as if they were further operators, because each of node A and node B can generate pairs of entangled qubits 140, 145, that can be sent to further receiving nodes, such as node C 150 (USER-1), node D 155 (USER-2), node E 160 (USER-3) and node F 165 (USER-4). A distribution from operator O 115 to nodes A and B can be referred to as a “layer 1” 170 distribution, and a distribution from node A and/or B to nodes C and D, and/or to nodes E and F, can be referred to as “layer 2” 175 transmission.

If a node A 130 and a node B 135 also act as further operators by generating further pairs of entangled qubits 140, 145, they can act as operator nodes for their respective child nodes, each 3-party group can be referred to as a subgroup, and node A and node B can each be referred to as a subgroup leader. Each subgroup can also be a trust group, and each subgroup or trust group can generate a group key that is specific to the subgroup or trust group.

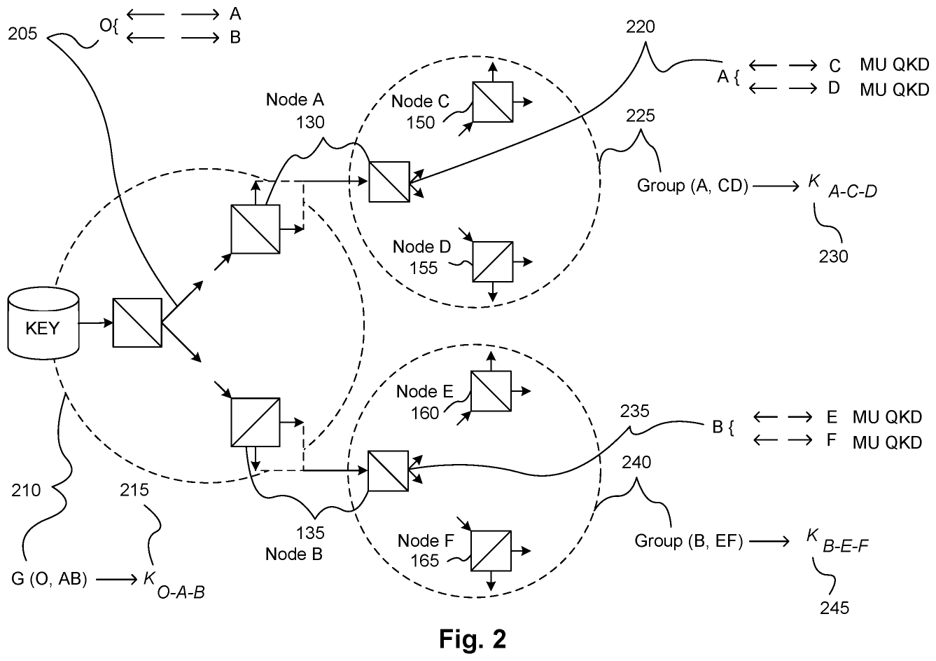

FIG. 2 illustrates a structure for multi-user quantum key distribution and stitching, where emphasis is placed on subgroups and related group keys, according to an embodiment. The illustration represents key distribution to a multi-layered group of nodes, from a central operator O 115, to its child nodes of a binary tree. Initially, a symmetrical key distribution 205 can occur from an operator at node O 115, to node A 130, and to node B 135, which together form group G(O, AB) 210. The key distributed and derived by nodes O, A and B can be referred to as K_{O-A-B} 215.

After a key K_{O-A-B} 215 has been derived, a further symmetrical key distribution 220 can occur from node A 130, to nodes C 150 and D 155, the three of which can be referred to as subgroup G(A, CD) 225. The resulting key, initially consisting of two copies of entangled qubits, can be referred to as K_{A-C-D} 230. Similarly, a further MU QKD 235 can occur from node B 135 to nodes E 160 and F 165, the group of which can be referred to as subgroup G(B, EF) 240, and the resulting key can be referred to as K_{B-E-F} 245.

In an embodiment where MU QKD takes place with a plurality of groups, as illustrated in FIG. 2, group key stitching refers to a group key verification protocol according to an embodiment, which can congregate, through at least one middle entity, two or more keys, into a combined group key, for the plurality of groups involved. In FIG. 2 for example, a middle entity can be node A 130, which is between two separated groups: Group G(O, AB) 210 and Group G(A, CD) 225. In such a case, a combined group key can be generated for the two groups, the combined group key being based on key K_{O-A-B} 215 and K_{A-C-D} 225.

In embodiments, a group key stitching trust model can be built upon security assumptions including:
There exists a strong centralized key operator, and trust is towards the centralized operator.
There exists secure key exchange mechanisms, such as MU QKD, to ensure the security properties of the group key stitching trust model.

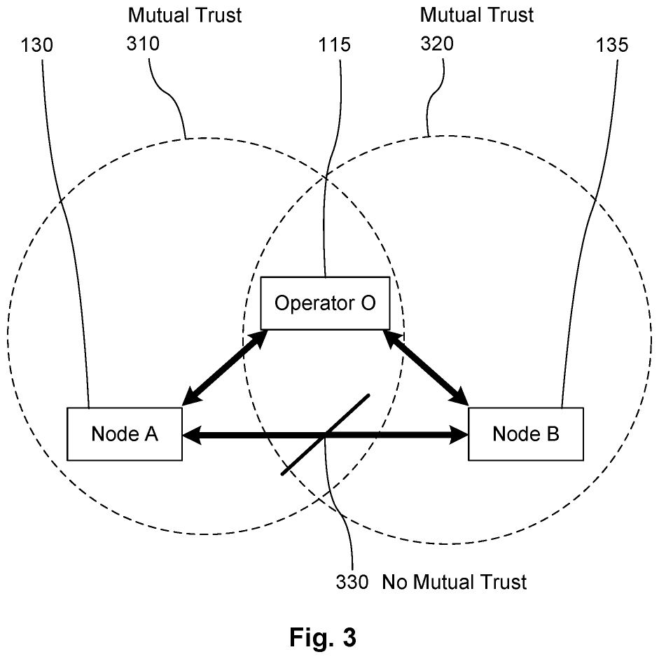

FIG. 3 illustrates a trust model with which group key stitching according to an embodiment can comply. This model includes a group of three network nodes and trust relations between the nodes. In this embodiment, an operator node O 115 can have a direct mutual trust relation 310 with a receiving node A 130, and a separate mutual trust relation 320 with a receiving node B 135. However, there isn't necessarily a trust relation 330 between node A and node B, such that mutual trust between them can only be achieved through node O 115.

In symbolic notation, trust relations can be represented as follows. A trust relationship between nodes O and A can be represented as:

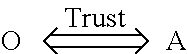

A trust relationship between O and B can be represented as:

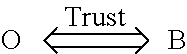

And a trust relationship between A and B, which must be through node O, can be represented as:

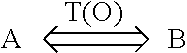

Without an operator node O, nodes A and B cannot achieve mutual trust. This can be expressed as:

$$A ≇ B$$

For achieving group key stitching through an operator O 115, and for establishing a trust model with a subgroup such as group G(A, CD) 225, the following steps can be performed by node A 130, once a key K(O-A-B) has been derived via MU QKD. Referring to FIG. 2:
Performing by node A, key distribution with 2-qubit entangled strings (i.e. MU QKD in each subgroup) from node A to node C and node D, and deriving group key K(A-C-D) 230.
Relaying by node A, through a classical channel which can be authenticated, key K(O-A-B) 215 to group G(A, CD) 225, and relaying key K(A-C-D) 230 to group G(O, AB) 210 (i.e. group key exchange):
   Encrypting by node A, key K(A-C-D) 230 with key K(O-A-B) 215;
   Sending by node A, encrypted key K(A-C-D) 230, to node O, via a classical channel;
   Encrypting by node A, key K(O-A-B) 215 with key K(A-C-D) 230;
   Sending by node A, encrypted key K(O-A-B) 215, to nodes C and D, via a classical channel.
Deriving a group key for groups G(O-A-B) 215 and G(A-C-D) 225 (i.e. “group key stitching”), by combining, such as by concatenating, keys K(O-A-B) 215 and K(A-C-D) 230, which can be expressed as:

$$K ( O ‐ A ‐ C ‐ D ) = K ( O ‐ A ‐ B ) ‖ K ( A ‐ C ‐ D )$$

Relaying by node A, a transmission from operator O, of a stitched group key confirmation request message Msg1, signed by O, to C and to D (i.e. stitched group key confirmation). Optionally, in order to prevent a MITM attack from an intercepting node A′ (i.e. an eavesdropper), an operator O can encode an identifier (ID) of node A into a signature key of O.
In parallel, a similar same process can be performed between node B, node E and node F.

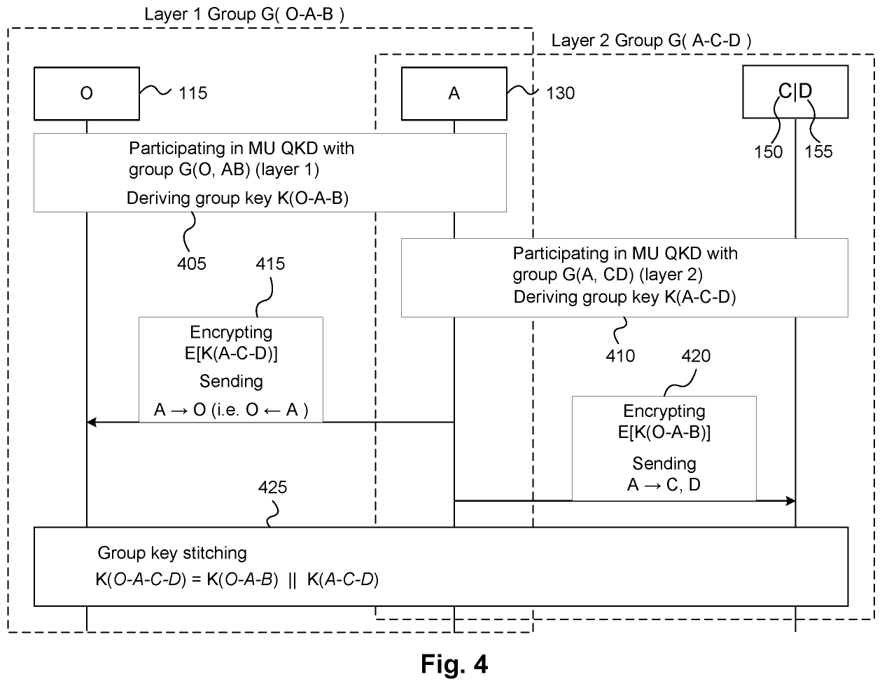

FIG. 4 is a call flow diagram representing the steps allowing stitching of a group key, according to an embodiment. Node A 130 can receive a string of entangled qubits from an operator node O 115, and participate in MU QKD with group G(O, AB) to derive a group key K(O-A-B) 405. Node A can also send strings of entangled qubits to nodes C 150 and node D 155. Node A can participate 410 in MU QKD as part of group G(A, CD), to derive a group key K(A-C-D). The result of both instances of MU QKD is that node A 130 has two quantum-based keys: K(O-A-B) and K(A-C-D). To send either of the two keys, node A 130 can therefore encrypt one with the other and vice versa.

In an embodiment, node A 130 can encrypt K(A-C-D) with K(O-A-B), and send 415 the result E[K(A-C-D)] to operator node O 115. Node A can also encrypt K(O-A-B) with K(A-C-D), and send 420 the result E[K(O-A-B] to node C 150 and to node D 155.

Once keys K(O-A-B) and K(A-C-D) have been received by the nodes of layer 1 and layer 2, they can be “stitched” (i.e. combined, such as by or concatenating them) to form a group key K(O-A-C-D) 425.

In an embodiment, stitching of a group key such as K(O-A-C-D) can be followed by a confirmation process. As an initial group key confirmation step, a confirmation request message can be sent from an operator node O 115, to nodes C and D, via relay by node A.

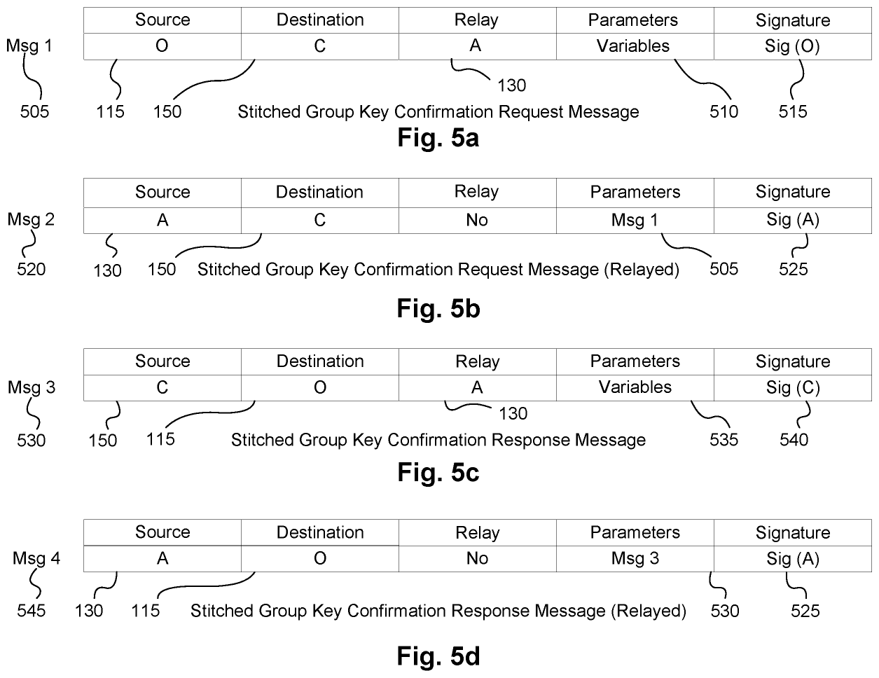

FIG. 5a illustrates features of a message requesting confirmation of a stitched group key, from an operator node O to a node C, according to an embodiment. A stitched group key confirmation request message “Msg1” 505 can be sent from operator O 115 to node C 150, via node A 130. The request message's content and parameters can include variables related to security 510, and it can be signed with a signature of O 515.

In a further group key confirmation step, there can be a stitched group key confirmation request message “Msg2”, from node A to node C.

FIG. 5b illustrates features of a request message from a node A to node C, to confirm a stitched group key, according to an embodiment. A request message “Msg2” 520, can be sent from node A 130 to node C 150 directly, with content and parameters that include Msg1 505, and it can be signed with a signature of A 525.

In a further group key confirmation step, there can be a response message “Msg3” from node C to operator O, to confirm a stitched group key.

FIG. 5c illustrates features of a response message from node C to operator O, confirming a stitched group key, according to an embodiment. A response message “Msg3” 530, can be sent from node C 150, via node A 130, to operator O 115, with content and parameters can include variables related to security 535, and it can be signed using a signature of node C 540.

In a further group key confirmation step, there can be a response message “Msg4”, from node A to operator O, to confirmation a stitched group key.

FIG. 5d illustrates features of a response message from a node A to an operator O, confirming a stitched group key, according to an embodiment. A response message Msg4 545 can be sent from node A 130 to operator O 115 directly, with content and parameters that include Msg3 530, using a signature of A 525.

A sender can use a secured hash function to sign a message. In particular, a message can be signed by a sending node (i.e. a source node) using a signature, such as Sig(O) 515, Sig(A) 525, and Sig(B) 540, that can be created using an integrity key “IK(source)”. An integrity key can be derived from a key derivation function (i.e. KDF), such as the hash-based message authentication code (HMAC) KDF, known as HKDF. Because identifiers for the sender (i.e. source), receiver (i.e. destination), and relay can be known by the nodes, as well as the group key, a recipient can reconstruct an integrity key that was sent to it. Identifiers can be referred to as ID(source), ID(destination), and ID(relay), and identity keys for Sig(O) 515, Sig(A) 525 and Sig(C) 540 can respectively be expressed as “IK(O)”, “IK(A)”, and “IK(C)”.

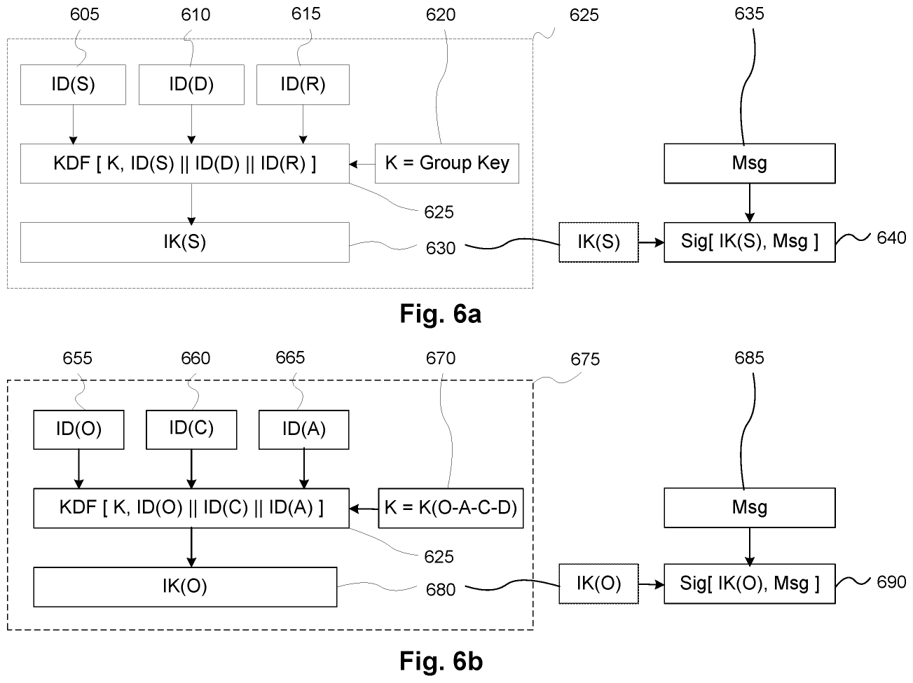

FIG. 6a illustrates a method by which an integrity key can be reconstructed from node identifiers and a group key, and be used to construct a sending node's signature, according to an embodiment. Identifiers for a source S, a destination D and a relay R, respectively ID(S) 605, ID(D) 610 and ID(R) 615, can be used by a signing node, along with a group key K 620. A key derivation function (KDF) 625, such as HKDF can be used to expand the key strength or entropy, and take ID(S), ID(D), ID(R) and the group key K as inputs, and produce an integrity key IK(S) 630 as an output. The IK(S) 630 can be used with a message Msg 635 to create a signed message Sig[IK(S), Msg] 640 for the sending node (i.e. message source).

FIG. 6b illustrates a method by which an integrity key can be reconstructed from node identifiers and a group key, and a signature can be created for a sending node, according to an embodiment where the nodes are those identified in FIGS. 1-5. A KDF 625 in operator node O can use identifiers for an operator O, a node C and a relay A, respectively ID(O) 655, ID(C) 660, and ID(A) 665, along with a group key K(O-A-C-D) 670, as input to create an integrity key IK(O) 680 as an output. The integrity key IK(O) 680 can be used with a message Msg 685 to create a signature 690 for the operator node O.

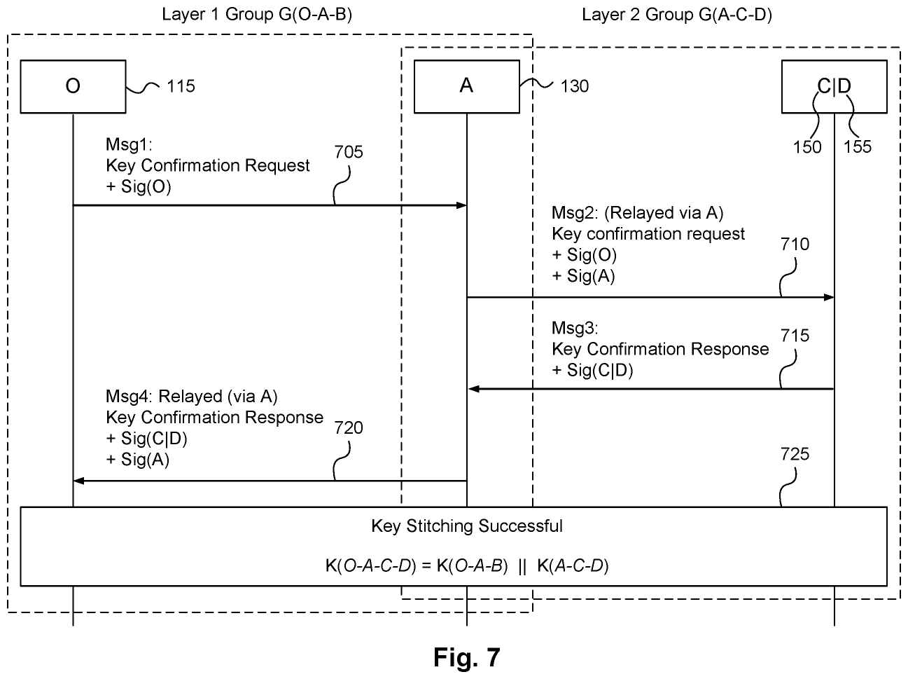

FIG. 7 is a call flow diagram representing steps allowing confirmation of a stitched group key, according to an embodiment. As an initial step, operator node O 115 can send 705 to node A 130 a key confirmation request, along with a signature of O, as a message Msg1 505. Node A 130 can add a signature of A and relay 710 the key confirmation request to node C 150 and node D 155, as a message Msg2. Nodes C and D, working at the same time or one after the other, can add their own signatures and send 715 a key confirmation response to node A, each one as a message Msg3 715. A key confirmation can be regarded as complete after node A has added a signature of node A, and relayed 720 a key confirmation response to operator node O. If an operator node O receives a key confirmation response, a key stitching process as in FIG. 4 to create key K(O-A-C-D) can be regarded as successful 725, and they key can be used.

In an embodiment, the calculation for stitching a group key can be linear, as opposed to other group key management protocols where it is are not. A baseline assumption in embodiments is that a trust model can be established through a middle anchor point, such as node A 130 in examples herein, which already has a pre-established, secure connection with a central anchor point, such as node O 115.

In embodiments, group dynamics, also called membership dynamics, can refer to events occurring when a party or group member joins a group (i.e. a node joins a network), leaves a group (i.e. a node leaves a network) or when a group undergoes other similar changes or updates. In such cases, a group key, whether derived directly from a 3-party MU QKD or with stitching as in embodiments, should keep ensuring the secrecy of the updated group, in particular when a member leaves a group.

In embodiments, “forward secrecy” refers to the property that when a node (i.e. member) leaves a group, the node should become unable to decode information circulating within the updated group. In an embodiment where a key has been stitched and a node or subgroup leaves a binary tree network, key management is simpler than with alternative schemes. In particular, the process of removing a leaving node or subgroup, which can include removing key parts of a particular subgroup, involves a linear calculation, which makes the cost of managing a key change simpler, more efficient and easier to implement than with group key algorithms of the prior art, such as GDH and similar schemes.

In embodiments, once a group key for multiple nodes has been stitched, a leaving process can include trimming the node, in reference to a tree structure. There can be two restrictions on such trimming. One restriction can be that trimming a node can also impact the peer member under the same root node, the peer member being the other child node having the same parent node. For example, in the case of group G(A, CD) 225, trimming node C 150 also causes peer member node D 155 to be removed. Another restriction can be that trimming a node can impact the subgroup under that node. For example, in the case of group G(A, CD) 225, trimming node C 150 can also cause further nodes, such as a node G and a node H, to be trimmed as well, and because node D is removed, nodes I and J are also removed.

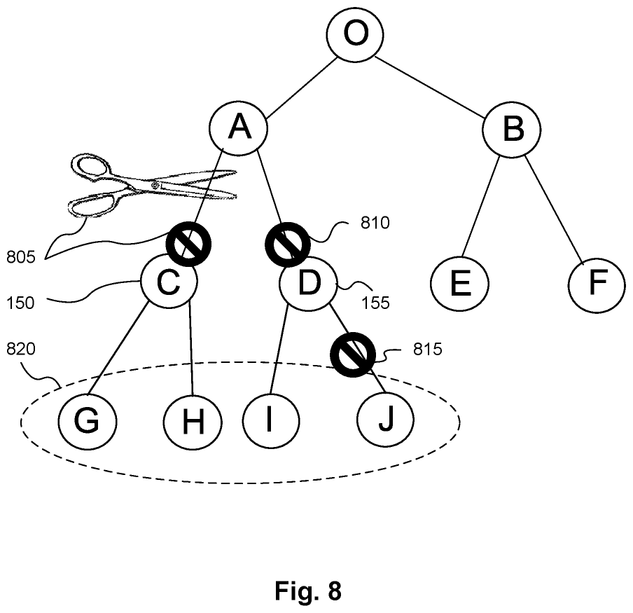

FIG. 8 illustrates removal of a node as it leaves a binary tree network, according to an embodiment. Each node of the illustrated binary tree is a node having participated in a MU QKD scheme according to embodiments. If node C 150 is removed 805 from the network, node D 155 is also removed 810, as well as all branches 815 or subgroups 820 of node C and node D.

An embodiment using multi-party quantum key distribution (MU QKD) can establish a multi-party secure communication based on a central anchor point, denoted as operator node O 115.

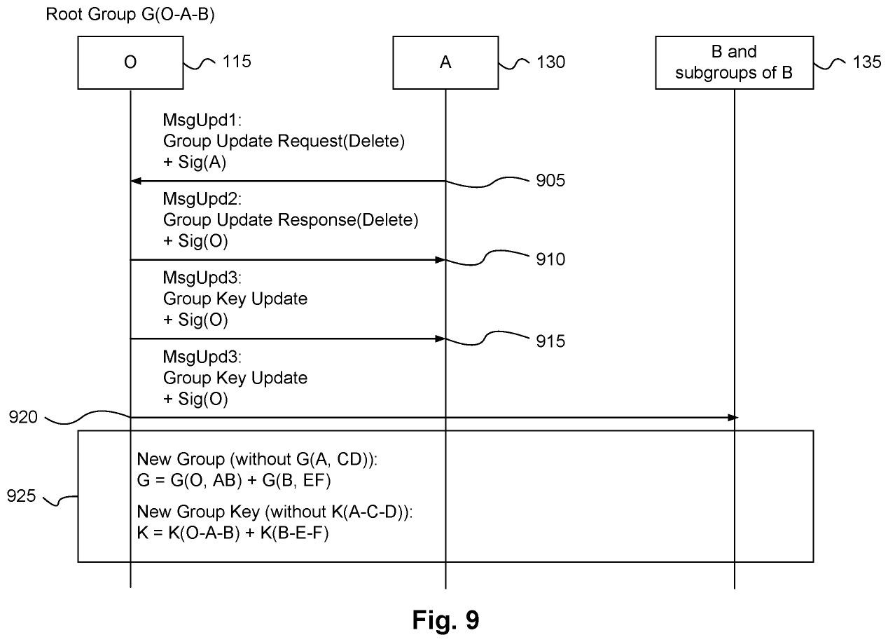

FIG. 9 is a call flow diagram illustrating a process for removing one or more nodes leaving a binary tree network, according to an embodiment. A node A 130 having branches with nodes C and D (not shown) leaving a network can send 905 to its root node, operator O 115, a message MsgUpd1 that includes a group update request to delete “Group Update Request(Delete)”, and a signature of node A: “Sig(A)”. Then, node A can receive 910 from the root node operator O 115 a response as MsgUpd2, “Group Update Response(Delete)”, along with a signature of node O: “Sig(O)”. After root node operator O 115 has updated the stitched group key, node A can then receive 915 from node O the updated stitched group key as a message MsgUpd3 including the updated stitched group key and a signature of O Sig(O). The operator node O 115 can also send 920 MsgRem3 to node B. The result of a process as in FIG. 9 is a new group, updated with nodes C and D removed, and a corresponding updated group key 925.

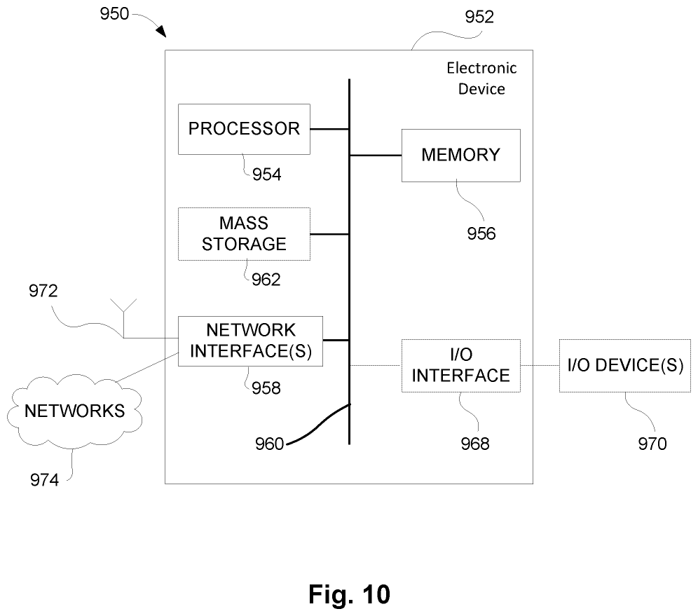

FIG. 10 is a block diagram of an electronic device (ED) 952 illustrated within a computing and communications environment 950 that may be used for implementing the devices and methods disclosed herein. Such an electronic device can be a UE or a network element. The electronic device 952 typically includes a processor 954, such as a central processing unit (CPU), and may further include specialized processors such as a field programmable gate array (FPGA) or other such processor, a memory 956, a network interface 958 and a bus 960 to connect the components of ED 952. ED 952 may optionally also include components such as a mass storage device 962, a video adapter 964, and an I/O interface 968 (shown in dashed lines). An ED 952 according to an embodiment can also include a cache.

The memory 956 may comprise any type of non-transitory system memory, readable by the processor 954, such as static random-access memory (SRAM), dynamic random-access memory (DRAM), synchronous DRAM (SDRAM), read-only memory (ROM), or a combination thereof. In an embodiment, the memory 956 may include more than one type of memory, such as ROM for use at boot-up, and DRAM for program and data storage for use while executing programs. The bus 960 may be one or more of any type of several bus architectures including a memory bus or memory controller, a peripheral bus, or a video bus.

The electronic device 952 may also include one or more network interfaces 958, which may include at least one of a wired network interface and a wireless network interface. A network interface 958 may include a wired network interface to connect to a network 974, and also may include a radio access network interface 972 for connecting to other devices over a radio link. The network interfaces 958 allow the electronic device 952 to communicate with remote entities such as those connected to network 974.

The mass storage 962 may comprise any type of non-transitory storage device configured to store data, programs, and other information and to make the data, programs, and other information accessible via the bus 960. The mass storage 962 may comprise, for example, one or more of a solid-state drive, hard disk drive, a magnetic disk drive, or an optical disk drive. In some embodiments, mass storage 962 may be remote to the electronic device 952 and accessible through use of a network interface such as interface 958. In the illustrated embodiment, mass storage 962 is distinct from memory 956 where it is included and may generally perform storage tasks compatible with higher latency, but may generally provide lesser or no volatility. In some embodiments, mass storage 962 may be integrated with a heterogeneous memory 956.

In some embodiments, electronic device 952 may be a standalone device, while in other embodiments electronic device 952 may be resident within a data center. A data center, as will be understood in the art, is a collection of computing resources (typically in the form of servers) that can be used as a collective computing and storage resource. Within a data center, a plurality of servers can be connected together to provide a computing resource pool upon which virtualized entities can be instantiated. Data centers can be interconnected with each other to form networks consisting of pools computing and storage resources connected to each by connectivity resources. The connectivity resources may take the form of physical connections such as ethernet or optical communications links, and in some instances may include wireless communication channels as well. If two different data centers are connected by a plurality of different communication channels, the links can be combined together using any of a number of techniques including the formation of link aggregation groups (LAGs). It should be understood that any or all of the computing, storage and connectivity resources (along with other resources within the network) can be divided between different sub-networks, in some cases in the form of a resource slice. If the resources across a number of connected data centers or other collection of nodes are sliced, different network slices can be created.

In embodiments, an electronic device 952 can be used at any node for receiving, processing, storing and/or receiving a string of bits as a key. It can also be used for stitching two group keys into one group key for a bigger group, and for encrypting a key with another key, prior to sending it to another node, according to embodiments. It can also be used for updating a key when a node leaves a network according to an embodiment. An electronic device can also be used to update a group key when one or more nodes leave a network. A memory 956 can be used for storing string of bits and any node. A network interface 958 can be used at any node to implement an authenticated classical channel between nodes, any of which can be used for communicating a key from a node to another node, or for communicating confirmation request messages and confirmation response messages according to embodiments.

Embodiments include a method of generating a key comprising: deriving a first key with a first node and a second node, deriving a second key with the second node and a third node, encrypting the first key with the second key, encrypting the second key with the first key, sending the encrypted first key to the third node, sending the encrypted second key to the first node, and deriving a stitched key from the first key and the second key; wherein a key is a cryptographic key made from a string of bits, the first node has a direct connection with the second node, and the second node has a direct connection with the third node. In embodiments, deriving a stitched key can be performed with a key derivation function (KDF). In embodiments, a key derivation function can be a hash-based message authentication code (HMAC) key derivation function (HKDF). In embodiments, deriving a stitched key from a first key and a second key can be performed by concatenating the first key and the second key. In embodiments, each node can be a node of a binary tree, the first node can be a parent node to the second node, the second node can be a child to the first node and a parent to the third node, and the third node can be a child to the second node. In embodiments, deriving a first key and deriving a second key can include at least one node sending a string of qubits to at least one receiving node, each qubit being in a state of 2-qubit entanglement. In embodiments, there can be a confirmation that the stitched key is common to the first and third node, the confirmation comprising the second node: receiving from the first node a message including: a confirmation request, and a signature of the first node; sending to the third node a message including: the confirmation request, the signature of the first node, a signature of the second node; receiving from the third node a message including: a confirmation response, a signature of the third node; sending to the first node a message including: the confirmation response, the signature of the third node, a signature of the second node. In embodiments, the signature of a node can include an integrity key derived with a key derivation function, the inputs of which can include at least: the stitched key, an identifier of the sending node, and an identifier of the receiving node. In embodiments, a key derivation function can be a hash-based message authentication code (HMAC) key derivation function (HKDF). In embodiments, inputs of a key derivation function can include an identifier of a relaying node.

Embodiments include a method of updating a cryptographic key for nodes of a binary tree network, comprising a first node: receiving from a second node a group update request for the deletion of a third node, sending to the second node a group update response and a signature of the first node, sending to the second node a group key update and a signature of the first node, sending to a fourth node a group key update and a signature of the first node; wherein the first node is a parent node to the second and fourth node, and the second node is a parent node of the third node. In embodiments, a method of updating a cryptographic key for nodes of a binary tree network can further include the first node: sending to a least one other node a group key update and a signature of the first node.

Embodiments include a system for performing quantum key distribution to multiple nodes comprising at least three nodes of a binary tree, the first node parent node to the second node, the second node a child to the first node and a parent to the third node, and the third node a child to the second node, each node operative to participate in quantum key distribution based on qubits in a state of 2-qubit entanglement. In embodiments, a system can include a second node and third node operative to derive a key between the second node and the third node, a first node and second node operative to derive a key between the first node and the second node, the second node operative to encrypt a key with another key and send the encrypted key to another node, the first node operative to derive a group key for the first node, second node and third node using the key between the second node and the third node, and the key between the first node and the second node. In embodiments, a system can further comprise one or more classical channels to communicate from one node to another node: key confirmation requests and key confirmation responses.

Embodiments include a machine readable medium storing machine readable instructions which when executed by a processor of a first node can configure the first node for receiving from a second node a group update request for the deletion of a third node, sending to the second node a group update response and a signature of the first node, sending to the second node a group key update and a signature of the first node, sending to a fourth node a group key update and a signature of the first node; wherein the first node is a parent node to the second and fourth node, and the second node is a parent node of the third node. In embodiments, a machine readable medium can include a first node further configured for: sending to a least one other node a group key update and a signature of the first node.

Embodiments include a machine readable medium storing machine readable instructions which when executed by a processor of a second node configures the second node for generating a key comprising: deriving a first key with a first node and the second node, deriving a second key with the second node and a third node, encrypting the first key with the second key, encrypting the second key with the first key, sending the encrypted first key to the third node, sending the encrypted second key to the first node, and receiving a stitched key from the first node, the stitched key derived by the first node from the first key and the second key; wherein a key is a cryptographic key made from a string of bits, the first node has a direct connection with the second node, and the second node has a direct connection with the third node. In embodiments, a stitched key can be a hash-based message authentication code (HMAC) key. In embodiments, deriving a first key can include a first node sending a string of qubits to a second node, each qubit being in a state of 2-qubit entanglement.

Other embodiments include the devices in which act as the nodes as described herein, including UEs and network elements.

Embodiments have been described above in conjunctions with aspects of the present invention upon which they can be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

What is claimed is:

1. A method of generating a key comprising:
deriving a first key with a first node and a second node,
deriving a second key with the second node and a third node,
encrypting the first key with the second key,
encrypting the second key with the first key,
sending the encrypted first key to the third node,
sending the encrypted second key to the first node, and
deriving a stitched key from the first key and the second key;
wherein
a key is a cryptographic key made from a string of bits,
the first node has a direct connection with the second node, and
the second node has a direct connection with the third node.

2. The method of claim 1, where deriving a stitched key is performed with a key derivation function (KDF).

3. The method of claim 2, wherein the key derivation function is a hash-based message authentication code (HMAC) key derivation function (HKDF).

4. The method of claim 1, where deriving a stitched key from the first key and the second key is performed by concatenating the first key and the second key.

5. The method of claim 1, wherein
each node is a node of a binary tree,
the first node is a parent node to the second node,
the second node is a child to the first node and a parent to the third node, and
the third node is a child to the second node.

6. The method of claim 1, wherein deriving a first key and deriving a second key include at least one node sending a string of qubits to at least one receiving node, each qubit being in a state of 2-qubit entanglement.

7. The method of claim 1, further comprising a confirmation that the stitched key is common to the first and third node, the confirmation comprising the second node:
receiving from the first node a message including:
a confirmation request, and
a signature of the first node;
sending to the third node a message including:
the confirmation request,
the signature of the first node,
a signature of the second node;
receiving from the third node a message including:
a confirmation response,
a signature of the third node;
sending to the first node a message including:
the confirmation response,
the signature of the third node,
a signature of the second node.

8. The method of claim 7, wherein the signature of a node comprises an integrity key derived with a key derivation function, the inputs of which include at least:
the stitched key,
an identifier of the sending node, and
an identifier of the receiving node.

9. The method of claim 8, wherein the key derivation function is a hash-based message authentication code (HMAC) key derivation function (HKDF).

10. The method of claim 8, wherein the inputs further comprise an identifier of a relaying node.

11. A system for performing quantum key distribution to multiple nodes comprising
at least three nodes of a binary tree,
the first node parent node to the second node,
the second node a child to the first node and a parent to the third node, and
the third node a child to the second node,
each node operative to participate in quantum key distribution based on qubits in a state of 2-qubit entanglement.

12. The system of claim 11, further comprising:
the second node and third node operative to derive a key
between the second node and the third node,
the first node and second node operative to derive a key
between the first node and the second node,
the second node operative to encrypt a key with another key and send the encrypted key to another node,
the first node operative to derive a group key for the first node, second node and third node using
the key between the second node and the third node, and
the key between the first node and the second node.

13. The system of claim 12 further comprising one or more classical channels to communicate from one node to another node: key confirmation requests and key confirmation responses.

14. A machine readable medium storing machine readable instructions which when executed by a processor of a second node configures the second node for generating a key comprising:
deriving a first key with a first node and the second node,
deriving a second key with the second node and a third node,
encrypting the first key with the second key,
encrypting the second key with the first key,
sending the encrypted first key to the third node,
sending the encrypted second key to the first node, and
receiving a stitched key from the first node, the stitched key derived by the first node from the first key and the second key;
wherein
a key is a cryptographic key made from a string of bits,
the first node has a direct connection with the second node, and
the second node has a direct connection with the third node.

15. The machine readable medium of claim 14 wherein the stitched key is a hash-based message authentication code (HMAC) key.

16. The machine readable medium of claim 14 wherein deriving the first key includes the first node sending a string of qubits to the second node, each qubit being in a state of 2-qubit entanglement.
